(19) United States
(12) Patent Application Publication
(10) Pub. No.: US 2004/0162745 A1
(43) Pub. Date: Aug. 19, 2004

(54) System and method to improve manufacturing

(75) Inventors: Rodney P. Rodrigue, Morrill, ME (US); John Dubois, Windham, ME (US); Maria Alfano, Celebration, FL (US); Dennis Grogan, Santa Monica, CA (US); Jennifer Comeau, Kennebunkport, ME (US); Sean M. Jordan, Essex Junction, VT (US); David Hess, Haverhill, MA (US); John Westberg, South Portland, ME (US); Lisa Westberg, Scarborough, ME (US); Anthony Perna, York, ME (US); Diane Morrissey, Colorado Springs, CO (US); Jerome Nelligan, Tiera Verde, FL (US)

Correspondence Address: CHRIS A. CASEIRO, VERRILL AND DANA, LLP, ONE PORTLAND SQUARE, PORTLAND, ME, 04112-0586, US

(73) Assignee: MSI Products, LLC, Augusta, ME

(21) Appl. No.: 10/753,992

(22) Filed: Jan. 8, 2004

Related U.S. Application Data
(60) Provisional application No. 60/438,906, filed on Jan. 9, 2003.

(51) Int. Cl. G06F 17/60

(52) U.S. Cl. 705/7

(57) ABSTRACT

A system and related method to train and aid manufacturers in identifying inefficiencies in product manufacturing processes and in improving such processes. The method includes an evaluation of an existing manufacturing operation and one or more training sessions to train representatives of the manufacturing organization in process improvement methods. The training session includes a manufacturing process simulation and customizable presentation materials. The system and method further include value stream mapping to identify the value of process improvements made, and a plan and means for implementing the process improvements. The system includes detailed forms, templates, and instructions for alternative means, selectable by a manufacturer, to implement the improvements. The system and method further include a process and means for following up on the implementation of the process improvements.

### CROSS REFERENCE TO RELATED APPLICATION

The present application claims the priority benefit of U.S. provisional patent application serial No. 60/438,906, filed Jan. 9, 2003, entitled “SYSTEM AND METHOD TO IMPROVE MANUFACTURING” of the same named inventors and assigned to a common assignee. The entire contents of that prior application are incorporated herein by reference.

### BACKGROUND OF THE INVENTION

1. Field of the Invention

The present invention relates to systems and methods designed to improve manufacturing processes. More particularly, the present invention relates to systems and methods to enable providers of goods and services to optimize productivity.

2. Description of the Prior Art

A principle goal of any provider of goods or services is to produce and supply to relevant consumers those goods or services in the most cost-effective way possible. Any aspect of the process involved in transforming raw materials into saleable product delivered to the consumer that does not add to the ultimate value of the product reduces productivity. The standard definition for productivity is the value of goods/services produced in a period of time divided by the number of hours of labor used to produce those goods/services. However, for the purpose of the present invention, productivity is more broadly defined as the value of goods/services produced in a period of time divided by the number of hours consumed to produce those goods/services. That is, productivity is dependent upon not only the time spent in actual goods/services creation, but the entirety of time spent from start to finish in getting goods/services ready for delivery to the consumer. That time necessarily includes the time associated with the eight wastes of: 1) overproduction of work in process; 2) waiting; 3) transportation of parts/materials/tooling; 4) non-value-added processing; 5) excess finished inventory; 6) defects; 7) excess people motion; and 8) underutilized people. The present invention is designed in a comprehensive way to enable goods/services providers to reduce the time associated with one or more of these eight wastes.

The evolution of manufacturing has been dependent upon the skills of individuals and the tools available to them to perform work. Prior to the Industrial Revolution, individual highly skilled artisans created what were effectively custom products. The individual was the manufacturer and bore direct responsibility for the work product. The Industrial Revolution brought automation into the process. The machine became the focus of the manufacturing process. The need for highly skilled workers performing individualized tasks bearing directly on the quality of the product output was reduced. The less-skilled individual became increasingly common as the standard worker forming a part of the repetitive process steps that produced standardized goods. The manager and the manufacturing process designer became responsible for suitable product output, the line worker much less so. The related process standardization resulted in improved productivity and a greater flow of standardized goods to greater numbers of consumers. The price of standardization was a reduction in the variety and quality of goods as compared to the customization associated with highly skilled workers. Manufacturing—rather than consumer interest—drove product availability.

Goods and services providers eventually came to the understanding that consumer interest, rather than manufacturing fit, was an important element in the generation of revenue. In addition, they have come to the understanding that in an increasingly competitive world, businesses survive when they align consumer desires with productive manufacturing methods. That is, goods and services desired by consumers should be produced with as little waste as possible. To that end, the idea of lean manufacturing has entered a substantial portion of the modern manufacturing world. For the purpose of the present invention, manufacturing includes the fabrication of finished physical products from raw materials, the design, financial aspects, human resources, management, marketing, sale, repair and/or maintenance of such products, and, similarly, services not specifically associated with any physical goods.

In simple terms, lean manufacturing (sometimes referred to as, or related to, just-in-time manufacturing, time-to-market, or any other name for a process with a similar purpose) is a systematic approach to identifying and eliminating waste (non-value-added activities) through improvements in a production process that is established not only by manufacturing techniques available but by consumer interest in the goods/services produced. It involves a careful review of each stage of the manufacturing process—from raw materials to shipped product—to confirm that each such stage has been optimized and that the process as a whole has been optimized.

A consulting industry has developed based on services made available to manufacturers to learn about and implement lean manufacturing techniques. Certain techniques taught by most “lean” consultants include: 1) the 5S System; 2) Pull/Kanban; 3) Total Productive Maintenance (TPM); 4) Inspection/Quality at the source; 5) Point of Use Storage (POUS); 6) Batch size reduction; 7) Quick changeover; 8) Visual controls; 9) Standardized work; 10) Plant layout; 11) Team-oriented manufacturing; and 12) Cellular manufacturing. Each of these techniques is described more fully in the detailed description section and related drawings of this application.

Because each manufacturing environment and product has its unique characteristics, it has heretofore been difficult to create a consistent, reproducible and effective process improvement training methodology that can be provided to an array of manufacturers. As a result, lean manufacturing consultants tend to fall into two categories. They either provide to all manufacturers the same generic training program that may or may not be applicable to each manufacturer's business model, or they create a new (customized) training program for each manufacturer. In the case of the generic offering, a completely standardized training program often fails to address particular process requirements of a specific manufacturer. It may lead to optimization (reduced waste) in some stages of the manufacturing process while failing to consider properly the effect of changes on the entirety of the process. Further, the generic training program is more likely than not to offer canned improvement solutions for all identified waste activities, which canned improvement solutions may not be optimal in all instances. A common attribute of the generic training system is the provision of written materials to the manufacturer without particular training in the use of those materials.

The customized process improvement training method also has its deficiencies. First, the lean manufacturing consultant tends to become comfortable recommending certain improvement solutions. As a result, customized training, like generic training, may include a limited array of solution offerings to the manufacturer. Second, the consultants who offer customized process improvement solutions tend to describe process stage failings without offering solutions, or the solutions offered are proprietary in nature and not reproducible by the manufacturer. The manufacturer is therefore not empowered to make future waste-reduction improvements throughout the entirety of the process, at least not without reliance on the consultant. These consultants fail to provide a comprehensive lean manufacturing methodology that is transparent to, and therefore may be implemented in the future by, the manufacturer. Customized training tends to involve little written material for the manufacturer to use, but is laden with oral disclosures and summary reporting. Customized lean manufacturing training can be expensive and may be difficult even for the trainer to reproduce.

More generally in regard to the offerings presently available from lean manufacturing consultants with generic or customized solutions, they fail to provide a comprehensive solution for the manufacturer that includes: 1) making the manufacturer aware of process and process stage waste; 2) an assessment or mapping of solution needs for particular identified waste activities; 3) planning for the implementation of the waste solution; 4) implementation of the waste solution; and 5) follow-up to assess solution effectiveness and, thereby, improved productivity.

What is needed is a training system to enable manufacturers to improve their productivity by reducing waste in the product creation process. Further, what is needed is such a system that can be applied to an array of manufacturers yet recognizes the uniqueness of each manufacturer and its processes. Also, what is needed is a transparent lean manufacturing training system that enables the manufacturer to carry the waste reduction techniques obtained from the trainer and apply them to all aspects of its present and future business. Such a system must be sufficiently simple to allow the manufacturer to subsequently train its own employees in the solution techniques applicable to their particular functions. In addition, the system must maintain a focus on complete optimization of the entire process and avoid sub-optimization based on undue attention to improvements of one or more individual stages. Yet further, what is needed is a lean manufacturing training system that: 1) identifies for the manufacturer waste within the process in its entirety and process stages individually; 2) provides an assessment or mapping of solution needs for particular identified waste activities; 3) plans for the implementation of the waste solution; 4) implements or aids in the implementation of the waste solution; and 5) includes follow-up to assess solution effectiveness.

### SUMMARY OF THE INVENTION

It is an object of the present invention to provide a training system to enable manufacturers to improve their productivity by reducing waste in the product creation process. It is also an object of the present invention to provide a lean manufacturing training system that can be applied to an array of manufacturers yet recognizes the uniqueness of each manufacturer and its processes. Further, it is an object of the present invention to provide a transparent lean manufacturing training system that enables the manufacturer to carry the waste reduction techniques obtained from the trainer and apply them to all aspects of its present and future business. Such a system is to be sufficiently simple to allow the manufacturer to subsequently train its own employees in the solution techniques applicable to their particular functions. Yet further, it is an object of the present invention to provide such a system that maintains the focus on complete optimization of the entire process and avoids sub-optimization based on undue attention to improvements of one or more individual stages. Finally, it is an object of the present invention to provide a training system that Yet further, what is needed is a lean manufacturing training system that: 1) identifies for the manufacturer waste within the process in its entirety and process stages individually; 2) provides an assessment or mapping of solution needs for particular identified waste activities; 3) plans for the implementation of the waste solution; 4) implements or aids in the implementation of the waste solution; and 5) includes follow-up to assess solution effectiveness.

These and other objects are achieved by the present invention through a comprehensive training system and methodology that empower the manufacturer to become a lean enterprise. The system of the present invention combines the best attributes of generic training and customized training to produce a complete solution that teaches the manufacturer how to improve its process in its entirety and the tools to make such improvements continuously—without extensive revisits from the training consultant. In brief, the present invention is a comprehensive and transparent system for effective improvements in manufacturing productivity. The system includes an evaluation of the present state of the manufacturing process of a particular manufacturer. It also includes a preliminary training program on lean manufacturing concepts, as described more fully herein. The training system of the present invention further includes a tool for mapping of process waste activities to be modified, a method for implementing a plan to reduce identified waste activities, and steps for following up on implementation. Unlike existing lean manufacturing methodologies, the present system enables the manufacturer to identify waste activities unique to its process, to select the best tool(s) to implement change in such activities, and to follow up on implementation.

As indicated, the system of the present invention includes a preliminary training process for the manufacturer. That preliminary training process teaches individuals from the manufacturer about lean manufacturing and tools that may be used by the manufacturer to implement lean manufacturing techniques. Those individuals are then trained to teach their fellow employees about the process improvement techniques. As part of this “train the trainer” process, the system of the present invention includes an organized suite of written materials that the trained employee may use in the future. The written aids are made available for the manufacturer to select based upon the particular process waste and/or stage where improvement is desired. Further, the training process of the present invention includes a simulation of a complete manufacturing activity, from acquisition of the raw materials through to completion of a finished product. The simulation involves the fabrication of a relatively simple product but is of such process detail that many of the potential waste points in a typical manufacturing process are considered.

The invention further includes an aid mechanism to assist the manufacturer in effecting any improvement changes it determines may be of value in increasing productivity. In particular, a Kaizen tool kit of the present invention provides the manufacturer with an organized system and accompanying templates and forms to break down process activities targeted for improvement into their most basic components. The kit allows the manufacturer to select the improvement technique that it determines best fits the improvement goal. The manufacturer is thereby empowered to achieve productivity improvements based on an implementation plan that it can generate in light of its process and facility limitations. The kit may be used by original equipment manufacturers, job shop facilities, and manufacturers with a plurality of facilities, at the front end and back end of the product process, and on internal supply chain functions.

The present invention is a system and related method that enable a manufacturer to increase productivity through the identification and reduction of wasteful components of an existing manufacturing process. These and other advantages of the present invention will become apparent upon review of the following detailed description, the attached drawings, and the appended claims.

### BRIEF DESCRIPTION OF THE DRAWINGS

FIG. 1 is a simplified flow diagram representing the comprehensive lean manufacturing system of the present invention.

FIG. 2 is a simplified flow diagram showing the steps associated with the diagnostic stage of the present lean manufacturing system.

FIG. 3 is a simplified flow diagram representing the training stage of the present lean manufacturing system.

FIG. 4 is a simplified flow diagram representing a preferred format of a training stage of the lean manufacturing system of the present invention including a simulation program.

FIG. 5 is a simplified flow diagram representing a combination of the value stream mapping and implementation planning stages of the present lean manufacturing system.

### DETAILED DESCRIPTION OF THE PREFERRED EMBODIMENT

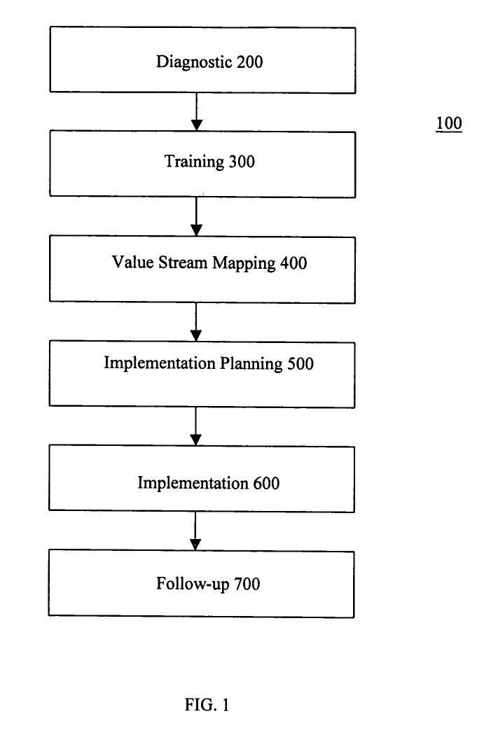

The present invention is a comprehensive system 100 for manufacturing process improvements that may be implemented by a manufacturer. The invention also includes system modules that enhance the likelihood that the manufacturer will be able to identify wasteful activities and train its employees to minimize such waste. As illustrated in FIG. 1, the comprehensive system 100 includes a diagnostic stage 200, a training stage 300, a value-stream mapping stage 400, an implementation planning stage 500, an implementation stage 600 and a follow-up stage 700. The manufacturer is provided with tools or the identification of appropriate tools, to be used at each stage as the means to identify, teach, assess, implement and track manufacturing processes, from front office through to product delivery and subsequent maintenance and support. The manufacturing process under consideration is first diagnosed, from start to finish, to obtain an understanding of the pre-improvement state of the process. The diagnostic stage 200 may be implemented initially by a trainer from outside of the manufacturing organization and then, after the manufacturer has gone through the improvement for a given process, by the manufacturer itself, or a combination of the two.

With continuing reference to FIG. 1, the training stage 300 supplies the manufacturer with an array of tools that may be employed in a lean manufacturing effort and an understanding of when they may be used. Initially, the training stage 300 would ordinarily be implemented by a consultant from outside the manufacturer but may subsequently be provided by trainers that are also manufacturer employees. The training stage 300 may also include a manufacturing process simulation that implements lean manufacturing techniques and tools provided during the training stage 300. The value mapping stage 400 provides an assessment of what gains in productivity may be generated through implementation of one or more of the process improvement techniques described in the training stage 300. Tools for mapping of value gains may be included as part of the value mapping stage 400.

The remaining stages of the comprehensive process improvement system 100 of the present invention may be implemented substantially by the manufacturer, based on the tools provided through the system 100. However, it may also be implemented completely or in part by one or more outside consultants. The implementation planning stage 500 establishes the framework for creating changes in individual steps of the overall manufacturing process so as to optimize the process by waste reduction. Waste activities are identified, steps for changing those activities are mapped and target goals are established. In the implementation stage 600, the planned steps are initiated pursuant to a schedule that may be understood by all participants in the process steps. Finally, the schedule preferably includes a schedule for meeting target waste reduction goals. The assessment of the effectiveness of the implemented waste reduction techniques forms the basis of the follow-up stage 700. That stage may also include a comprehensive assessment of the overall improvement in productivity associated with the particular improvements implemented in stage 600. It is to be understood that the comprehensive system 100 of the present invention may include one or more combinations of the stages identified herein but does not specifically require the combination of all of those stages in order to generate productivity improvements.

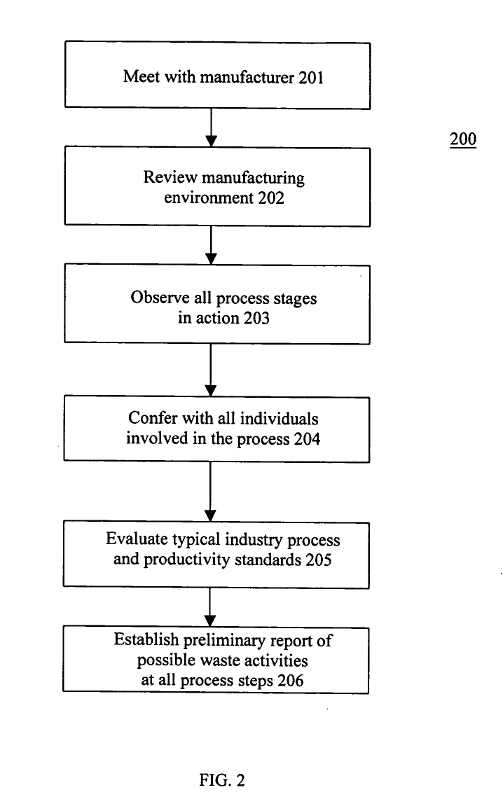

As illustrated in FIG. 2 for process improvement initially enabled by an outside consultant, the diagnostic stage 200 includes several process steps to begin the effort to improve a manufacturer's productivity. First in step 201, the consultant meets with the manufacturer to establish an understanding of the manufacturer's goals for improvement. That may include a targeted productivity improvement, a manpower target, etc. Second in step 202, the environment associated with the manufacturing process is reviewed to assess the potential impact of environmental waste on productivity. That may include a review of component organization, machinery location and maintenance, employee positioning, and the existence in the workspace of materials that are not directly related to the particular process stage. Third in step 203, the entirety of the manufacturing process in action is observed to obtain a comprehensive understanding of the interaction of individual process steps and the impact of individual process stages on the whole.

With continuing reference to FIG. 2, the diagnostic stage 200 further includes in step 204 a meeting or series of meetings with all individuals bearing any sort of responsibility on the manufacturing process under review. That meeting or meetings may be used to gather initial information on process improvement ideas from those individuals, to convey a sense of teamwork in the process improvement, and to introduce the idea of lean manufacturing as a target. In step 205, an evaluation is performed to identify information indicating typical industry processes and productivity related to the particular process under review. That information may be used to educate the manufacturer and to aid in the establishment of target improvement methods and/or goals. Finally, in step 206, a preliminary report of findings gathered in steps 201 through 205 is generated and supplied to the manufacturer. Potential identified waste activities may be provided in the report along with an indication of the existence of improvement tools that may be applicable to reduce such identified waste activities. It is to be understood that while step 201 will likely include the involvement of an outside consultant, the remaining steps may alternatively, or in combination with the outside consultant, be carried out by the manufacturer, particularly after that manufacturer has been trained pursuant to the training stage 300 of the present invention.

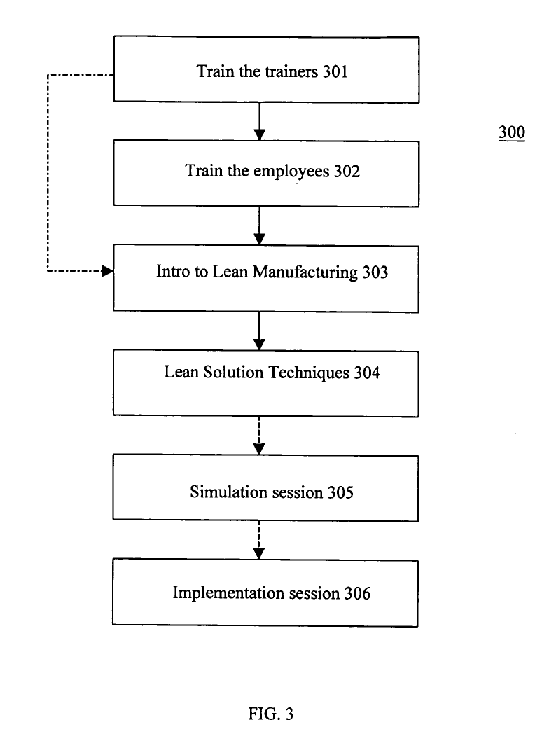

While the training stage 300 is identified in this description as occurring after the diagnostic stage 200, it may alternatively occur prior to or in parallel with that stage. As illustrated in FIG. 3, the training stage 300 includes two primary steps. First in the “train-the-trainer” step 301, the individuals designated to train management and other employees of the manufacturer in techniques of lean manufacturing are trained in those techniques. In second step 302, those initially trained trainers teach the lean manufacturing techniques that they've learned, preferably including the means to implement those techniques, to the relevant manufacturing participants. Of course, once the trainers have been trained, step 301 may be omitted in future training stages wherein the individuals involved in the stages of product processing are taught from the outset by trainers that have previously learned the techniques. In each of the training steps, a program is established that includes, at a minimum, an introduction to lean manufacturing step 303 and a step 304 that describes lean manufacturing techniques and tools to use in their implementation. Optionally, the training stage 300 includes a simulation session or sessions 305 to provide an experiential introduction to the lean manufacturing problems described and an implementation session 306 to implement the solution techniques as part of the simulation.

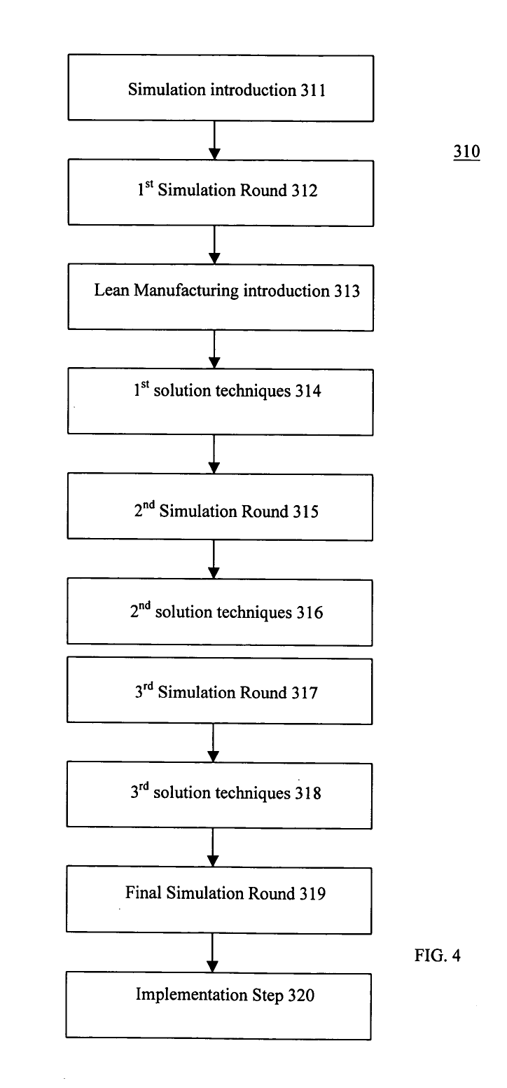

In the preferred embodiment of the present invention, the training stage 300 includes the interactive simulation of a manufacturing process in which waste activities are illustrated, solutions discussed, and improvement tools provided to the participants. In step 301, the participants are individuals who will become trainers and in step 302, the participants are the individuals who should eventually implement improvement techniques in the manufacturer's actual production process. As illustrated in FIG. 4, a simulation-based training session 310 of the present invention includes a simulation introduction step 311, a first simulation round 312, a lean manufacturing introduction step 313, a first solution techniques description step 314, a second simulation round 315, a second solution techniques description step 316, a third simulation round 317, a third solution techniques description step 318, a final simulation round 319, and an optional implementation step 320.

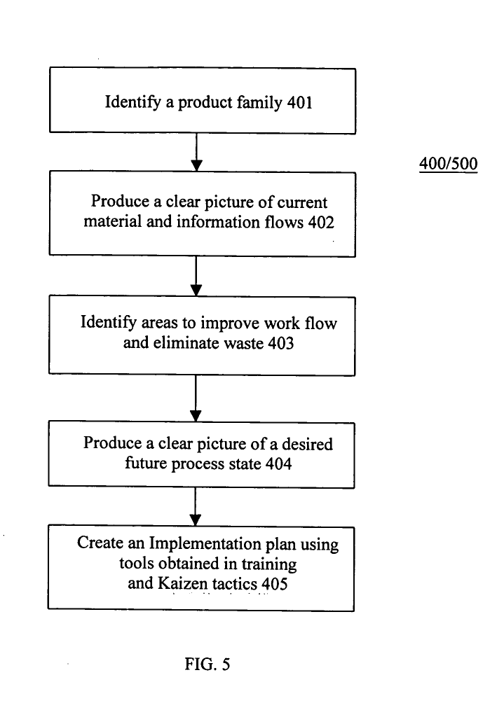

The introduction step 311 of the simulation includes a description of a hypothetical company named Time Wise, Inc. that makes clocks. FIGS. 5A-5J of U.S. provisional patent application No. 60/438,906, incorporated herein by reference, include a representation of a slide to be shown to the individuals being trained and may include information for the training facilitator who describes the material based on the slide. The information provided for the facilitator preferably includes an indication of the intent of the slide, the recommended content of the oral presentation and any materials associated with the slide, and tips to ensure that the desired information is being transferred and retained by the trainees. In the simulation of the preferred embodiment of this invention, the hypothetical company is run by a simulated strict boss who teaches his/her employees to perform the clock making steps for two types of clocks, the “Black Diamond” and the “Blue Sapphire,” in very specific ways. The boss teaches a “push” concept of manufacturing. That is, product is to be built at capacity rather than as a function of customer ordering needs or the “pull” concept of manufacturing. Of course, alternative simulation schemes may be applied to the training stage 300; however, it appears preferable to run the simulation with a product well known to most individuals but of sufficient complexity to make the manufacturing process non-trivial. The introduction step 311 provides enough detail of the planned simulation to prepare the individuals being trained for the task at hand.

Upon completion of step 311, the introduction to the simulation based on existing process steps, the first round of the simulation described may be carried out pursuant to step 312. That is, the individuals being trained begin the process of actually making the clock. The individuals involved in the first round of production may then be debriefed to determine whether they have learned of any wasteful steps as part of the push manufacturing process specified by the strict boss. Part of the debriefing includes a measure of actual versus targeted output and an instruction from the hypothetical boss that lean manufacturing steps are to be implemented.

FIGS. 6A-6G of the provisional patent application incorporated herein by reference illustrate features of the introduction to lean manufacturing identified in step 313 of FIG. 4. The set of slides and corresponding notes of the referenced figures provide the individuals in training with a brief overview of the history of manufacturing, the shortcomings previously described herein regarding the general goals of waste reduction and the eight waste types in particular. That introduction includes an effort to have participants relate their experience in the first round of the simulation with the eight wastes. Finally, this step 313 of the training session 310 includes an initial description of the systematic approach involved in waste reduction through lean manufacturing. It further indicates that tools, or solutions, are available and may be employed in order to achieve lean manufacturing in an organized manner.

FIGS. 7A-7H of the provisional patent application incorporated herein by reference illustrate features of the first lean manufacturing techniques disclosure, corresponding to step 314. In the first solution disclosure step 314, the concepts and advantages of standardized work, the 5S's, visual controls, and plant layout are presented. These techniques are more fully explained in the related drawings. It is to be understood that the order of the entirety of solution techniques described in the training session 310 of the present invention may be varied without deviating from the goal of disclosing all such known techniques in the context of a production simulation designed to allow for practical application of those solutions.

Upon completion of step 314, the second round of the simulation described may be carried out pursuant to step 315. However, rather than employ the process steps as directed by the hypothetical boss, the participants are urged to consider the first set of lean manufacturing solution techniques described in step 314 as part of a consideration of ways to improve the clock making process first used in step 312. That is, the individuals being trained return to making the clock, or at least discuss the process of making the clock with an eye to the first set of solution techniques. The individuals involved may then be debriefed to determine whether they have learned of any advantages associated with the implementation of the new concepts useful in reducing wasteful activities. If the time is available, this second debriefing optionally includes a measure of actual versus targeted output.

FIGS. 8A-8O of the provisional patent application incorporated herein by reference illustrate the features of the second lean manufacturing techniques disclosure, corresponding to step 316 of FIG. 4. In the second solution disclosure step 316, the concepts and advantages of organizational culture, quick changeover, batch reduction, quality at the source, and point-of-use supply are presented. These techniques are more fully explained in the related drawings. As earlier noted, it is to be understood that the order of the entirety of solution techniques described in the training session 310 of the present invention may be varied without deviating from the goal of disclosing all such known techniques in the context of a production simulation designed to allow for practical application of those solutions. Linking elements may also be employed in providing further and/or customized detail related to the particular solution techniques disclosed.

Upon completion of step 316, the third round of the simulation described may be carried out pursuant to step 317. The participants are urged to consider using the second set of lean manufacturing solution techniques described in step 316 as part of a consideration of ways to improve the clock making process first used in step 312. That is, the individuals being trained return to making the clock, or at least discuss the process of making the clock with an eye to employing the first and second set of solution techniques. The individuals involved may then be debriefed to determine whether they have learned of any advantages associated with the implementation of the new concepts useful in reducing wasteful activities. If the time is available, this third debriefing optionally includes a measure of actual versus targeted output.

FIGS. 9A-9N of the provisional patent application incorporated herein by reference illustrate the features of the third and final lean manufacturing techniques disclosure, corresponding to step 318. In the third solution disclosure step 318, the concepts and advantages of total product maintenance, pull/Kanban, and cellular flow are presented. These techniques are more fully explained in the related drawings. As earlier noted, it is to be understood that the order of the entirety of solution techniques described in the training session 310 of the present invention may be varied without deviating from the goal of disclosing all such known techniques in the context of a production simulation designed to allow for practical application of those solutions. Linking elements may also be employed in providing further and/or customized detail related to the particular solution techniques disclosed.

Upon completion of step 318, the fourth and final round of the simulation described may be carried out pursuant to step 319. The participants are urged to consider using the lean manufacturing solution techniques described, focusing on the techniques described in step 318 as part of a consideration of ways to improve the clock making process first used in step 312. That is, the individuals being trained return to making the clock, or at least discuss the process of making the clock, with an eye to employing the lean manufacturing solution techniques. The individuals involved may then be debriefed to determine whether they have learned of any advantages associated with the implementation of the new concepts useful in reducing wasteful activities. If the time is available, this fourth debriefing optionally includes a measure of actual versus targeted output.

Finally, in step 320 of the training session 310 of the present invention, the concepts disclosed throughout the program are summarized. In addition, recommendations are made to implement the lean manufacturing techniques described and simulated as part of a systematic approach to improve continuously all aspects of the manufacturer's existing processes. The implementation step 320 of the training session 310 may include a statement of reasons to implement lean manufacturing techniques and timelines for doing so. The implementation recommendations may further include reference to the value stream mapping stage 400 to be described more fully herein, the advantage to expand the use of lean techniques to all aspects of the business including, but not limited to front end and back end processes. General benchmarks of the likely successful outcome of lean implementation include leadership dedicated to the implementation, a strategic vision of a systematic implementation, consideration of all successes and failures, critical assessment of the need for all activities related to a process, and a commitment to excel at all phases of the process.

Completion of the training stage 300 for trained trainers and participants who are to form the parts of the teams to implement lean manufacturing techniques in their enterprise leads next to a mapping of the process areas requiring waste reduction and plan to implement waste reduction activities. The desired improvement in productivity sought based on the implementation of lean manufacturing should form part of this mapping as a desired future manufacturing state. This mapping may be generated by the manufacturer, by an outside consultant familiar with the full array of improvement tools available, or a combination of the two. One example of such a tool is the value stream mapping system made available by Lean Enterprise Institute, Inc. of Brookline, Mass., www.lean.org.

As illustrated in FIG. 5, the value stream mapping stage 400 of the system of the present invention may be combined with the implementation planning stage 500 to produce targets for improvement, a plan for the improvement, and the desired outcome of the plan. First in step 401, a target product, product family, or process must be identified for either a pilot improvement effort or, if a pilot has been done or not deemed to be necessary, a full-scale improvement effort. Next in step 402, the existing state of the process or processes currently employed to create that target product, as well as the work environment and setup should be mapped. That mapping may be beneficial in targeting waste activities and as an aid in comparing the outcomes of changes made. In step 403, those areas in apparent need of improvement, based on the understanding of the eight wastes described in the training stage 200, are also mapped.

With continuing reference to FIG. 5; in step 404, a desired future process state is created. That future process state should be designed to change the waste activities identified in step 403. The future process state mapping may include diagrammatic representations of workflow modifications, floor plan layouts, personnel movement and the like. It should also include a desired productivity improvement sought by the changes to be implemented. Finally, as part of the implementation planning stage 500, in step 405, the techniques of lean manufacturing described in the training stage 200 are mapped to the particular waste activities to be changed. In general in prior lean manufacturing training systems offered by consultants, the manufacturer would not be provided with the recommendation to consider all reduction techniques. Instead, particular consultants tend to suggest solution tools with which they have familiarity. However, particular manufacturers with specific product types and historical process methods may not be best served by using a limited set of implementation tools. For that reason, the present invention provides for the implementation planning to include the option for the manufacturing to use the improvement tool best suited for the particular desired future process state.

A known methodology for implementing lean manufacturing process improvements is the Kaizen method. The application of that implementation method is included in step 405 of the mapping and planning stages of the improved system of the present invention. The Kaizen method was developed in Japan. It is intended to enable continuous improvements through incremental improvements. The goal is to eliminate identified waste activities by making tasks simpler and easier to perform by breaking them down into their most basic components and then focusing on those simplified components for change, as needed and without compromising safety and product quality. Unfortunately, while the Kaizen concept is known, it has heretofore been amorphous and therefore difficult to employ effectively in establishing a lean manufacturing environment in a facility that has an entrenched process in place.

The present invention includes a set of Kaizen-based tools that increase the likelihood that the manufacturer will effect the process changes defined in the mapping and implementation planning stages 400/500 of the system 100. The tools are provided in a kit. The tools include physical components, such as stop watches, calculators, markers, tape, Post-It™ notes, recording paper, and any other physical components that the particular manufacturer may deem to be of value in the effort to implement mapped process changes. The kit further includes a set of templates and forms designed to organize and clarify the type of information and efforts required to implement a targeted process change. The templates and forms further include summary descriptions of the purpose of the form or template, the type of solution technique to be employed to reduce the targeted waste activity (e.g., 5S, TPM, Kanban, etc.), the intended user of the form or template and procedures for completing it. A set of Kaizen forms and templates of the present invention, including completed sections with reference to hypothetical example improvement activities are presented in FIGS. 11A-11CCC of the provisional patent application incorporated herein by reference. The kit may include some or all of the templates and forms in that set of drawings. The kit and the broader related method of instituting Kaizen implementation techniques in concert with the lean manufacturing solutions described in the training session 310 increase the likelihood that the manufacturer will be able to increase productivity.

The remaining stages of the comprehensive improvement system 100 of the present invention include implementation of the mapped improvements as shown in step 600 of FIG. 1, preferably facilitated by use of the Kaizen methods and templates and forms, and a follow-up analysis of the outcome of the improvements implemented as shown in step 700. These two stages may be undertaken by the manufacturer, an outside consultant, or a combination of the two. The metrics established in the value stream mapping stage 400 define the target goals to be considered in the follow-up stage.

While the present invention has been described with specific reference to a particular embodiment, it is not limited thereto. Instead, it is intended that all modifications and equivalents fall within the scope of the following claims.

What is claimed is:

1. A method for training one or more individuals to improve manufacturing operations, the method comprising the steps of:
a. conducting a preliminary evaluation of an existing manufacturing operation;
b. providing to the one or more individuals a preliminary training session to the one or more individuals, the training session to include an overview of improved manufacturing techniques;
c. providing to the one or more individuals a tool for mapping wasteful activities associated with the existing manufacturing operations;
d. providing to the one or more individuals a tool for generating and implementing a plan to modify the mapped wasteful activities; and
e. providing to the one or more individuals a tool for following up on the implementation of the plan to modify the mapped wasteful activities.

2. The method as claimed in claim 1 wherein the tool for mapping wasteful activities, the tool for generating and implementing the plan to modify the wasteful activities, and the tool for following up on the implementation of the plan form part of a single tool system.

3. The method as claimed in claim 1 wherein the step of providing to the one or more individuals a preliminary training session includes the step of providing information about lean manufacturing and lean manufacturing implementation tools.

4. The method as claimed in claim 1 further comprising the step of training the one or more individuals to train others in methods to improve the existing manufacturing operation.

5. The method as claimed in claim 4 wherein the step of training others includes the step of training the others in lean manufacturing techniques and the use of tools for implementing lean manufacturing techniques.

6. The method as claimed in claim 1 wherein the training session includes the step of simulating a complete manufacturing activity.

7. The method as claimed in claim 6 wherein the step of simulating a complete manufacturing activity includes the steps of:
a. producing a product with a first set of manufacturing steps;
b. evaluating the time and cost involved in producing the product with the first set of manufacturing steps;
c. adjusting the manufacturing steps based on the evaluation to create a second set of manufacturing steps;
d. producing the product with the second set of manufacturing steps; and
e. generating a representation of cost and time savings resulting from producing the product with the second set of manufacturing steps.

8. The method as claimed in claim 1 wherein the tool for mapping wasteful activities associated with the existing manufacturing operations is a Kaizen tool kit.

9. The method as claimed in claim 8 wherein the Kaizen tool kit includes a plurality of templates to break down into specific process steps the existing manufacturing activity.

10. The method as claimed in claim 9 wherein the Kaizen tool kit further includes a plurality of process improvement techniques selectable by the one or more individuals to correct identified wasteful activities.

11. The method as claimed in claim 10 wherein the one or more individuals are associated with an original equipment manufacturer, a job shop facility, or a manufacturer with a plurality of manufacturing facilities.

12. The method as claimed in claim 10 wherein the one or more individuals are associated with the front end of the existing manufacturing operation, the back end of the existing manufacturing operation, or a supply chain function of the existing manufacturing operation.

13. The method as claimed in claim 1 the tool for generating and implementing a plan to modify the mapped wasteful activities includes a value stream mapping tool for relating manufacturing operation changes to cost savings.

14. A system for training one or more individuals to improve an existing manufacturing operation, the tool comprising:
a. a diagnostic stage for evaluating the existing manufacturing operation;
b. a training stage for presenting lean manufacturing techniques;
c. a value-stream mapping stage for relating operations changes with productivity improvements;
d. an implementation planning stage for identifying specific manufacturing activities to be modified and means for modifying them;
e. an implementation stage for implementing the planned modifications to the manufacturing activities to be modified; and
f. a follow-up stage to evaluate the impact of the implemented modifications.

15. The tool as claimed in claim 14 wherein the diagnostic stage includes a review of the manufacturing operations environment.

16. The tool as claimed in claim 15 wherein the review of the manufacturing operations environment includes a review of component organization, machinery location and maintenance, employee positioning, or unrelated materials in an identified workspace.

17. The tool as claimed in claim 14 wherein the diagnostic stage includes an evaluation of related industry process standards and productivity information.

18. The tool as claimed in claim 14 wherein the diagnostic stage includes a report of findings on the existing manufacturing operations and potentially wasteful activities associated with the existing manufacturing operations.

19. The tool as claimed in claim 14 wherein the training stage includes a train-the-training stage and a train-the-participants stage.

20. The tool as claimed in claim 14 wherein the training stage includes teaching lean manufacturing techniques.

21. The tool as claimed in claim 14 wherein the training stage includes a simulation session for simulating a manufacturing process including a lean manufacturing process.

22. The tool as claimed in claim 21 wherein the simulation session includes:
a. a first simulation round;
b. a lean manufacturing introduction step;
c. a first solution techniques description step;
d. a second simulation round;
e. a second solution techniques description step;
f. a third simulation round;
g. a third solution techniques description step; and
h. a final simulation round.

23. The tool as claimed in claim 22 wherein the simulation session further includes an implementation step.

24. The tool as claimed in claim 21 wherein the simulation session includes fabrication of a product having a plurality of parts to combine together.

25. The tool as claimed in claim 24 wherein the product is a clock.

26. The tool as claimed in claim 14 further comprising a presentation device to illustrate techniques and solutions described in the training stage.

27. The tool as claimed in claim 26 wherein the presentation device is an illustrative slide show.

28. The tool as claimed in claim 27 wherein the illustrative slide show includes one or more solution link elements representing selectable connections to presentation material associated with the existing manufacturing operation.

29. The tool as claimed in claim 28 wherein the presentation material is selected from the group consisting of photographs, charts, diagrams, databases, spreadsheets, blueprints, reports, memoranda, notes, correspondence, and communications.

30. The tool as claimed in claim 28 wherein the presentation material illustrates a disorganized workstation prior to the implementation stage and the same workstation as organized after the implementation stage.

31. The tool as claimed in claim 22 wherein the first solution techniques description step includes descriptions of standardized work, the 5S's, visual controls, and plant layout.

32. The tool as claimed in claim 31 wherein the second solution techniques description step includes descriptions of organizational culture, quick changeover, batch reduction, quality at the source, and point-of-use supply.

33. The tool as claimed in claim 32 wherein the third solution techniques description step includes descriptions of total product maintenance, pull/Kanban, and cellular flow.

34. The tool as claimed in claim 14 wherein the value stream mapping stage includes a description of a desired future process state.

35. The tool as claimed in claim 34 wherein the value stream mapping stage includes one or more of: one or more diagrammatic representations of flow modifications, floor plan layouts, and personnel movement.

36. The tool as claimed in claim 34 wherein the value stream mapping stage includes one or more recommendations for process changes and a listing of one or more techniques for making those process changes.

37. The tool as claimed in claim 36 wherein one of the one or more techniques is the Kaizen method, the tool further comprising a Kaizen kit.

38. The tool as claimed in claim 37 wherein the Kaizen kit includes physical components, templates, forms, and summary descriptions of the functions of the templates and forms.
